(19) United States
(12) Patent Application Publication
(10) Pub. No.: US 2005/0261490 A1
(43) Pub. Date: Nov. 24, 2005

(54) Method for producing temporarily cross-linked cellulose ethers

(76) Inventors: Eberhard Perplies, Walluf (DE); Manfred Erdler, Hofheim (DE)

Correspondence Address: Klaus Schweitzer;ProPat, 425 C South Sharon Amity Road, Charlotte, NC, 28211, US

(21) Appl. No.: 10/524,455

(22) PCT Filed: Aug. 19, 2003
(86) PCT No.: PCT/EP03/09150

§ 371 Date: Feb. 10, 2005

(30) Foreign Application Priority Data
Aug. 28, 2002 (DE) 102 39 442.3

(51) Int. Cl. C08B 13/00; C08B 11/20

(52) U.S. Cl. 536/66; 536/85

(57) ABSTRACT

Modified cellulose ethers are obtainable by admixing cellulose ethers having free OH groups with chemical compounds containing at least one aldehyde group and at least one acid group, and then reacting the acid groups and the aldehyde groups with the free OH groups of the cellulose ethers. The cellulose ethers modified in this way are distinguished by an improved lump-free stirrability into water and a salvation delay which can be adjusted in a targeted manner.

The present invention relates to a method for producing temporarily crosslinked cellulose ethers having improved lump-free stirrability and solvation delay on stirring into aqueous solutions.

The production of cellulose ethers having uniform or different substituents is known, for example from Ullmann's Enzyklopadie der Technischen Chemie, Bd. 9, “Celluloseether” [Ullmann's Encyclopedia of Industrial Chemistry, Vol. 9, “Cellulose ethers”], Verlag Chemie, Weinheim, 4^{th} Edition 1975, pp. 192 ff.

To produce these cellulose ethers, for example methylcellulose, ethylcellulose, carboxymethylcellulose, hydroxyethylcellulose, hydroxypropylcellulose, methylhydroxycellulose, methylhydroxypropylcellulose and ethylhydroxyethyl-cellulose, the starting material, the cellulose, is first ground to increase its surface area, in which the particle size should generally be less than 2.5 mm, as far as possible even less than 1 mm. The resultant voluminous cellulose powder is converted into “alkali cellulose” by adding base, for example NaOH, KOH, LiOH and/or NH₄OH, in solid or liquid form. It is followed by, with or without isolation of the alkali cellulose, a single- or multistage, continuous or batchwise etherification with the corresponding reagents. The resultant cellulose ethers are purified from reaction byproducts in a known manner using water or suitable solvent mixtures, dried, ground and if appropriate blended with other components.

Despite good solubility of these cellulose ethers in cold water, the production of aqueous solutions of the same is frequently a problem. This applies, in particular, when the cellulose ether is present as fine powder having enlarged surface area. If such a cellulose ether powder comes into contact with water, the individual granules swell and clump together to form relatively large agglomerates, the surface of which is thickened in a gel-like manner. However, depending on the mixing intensity, a certain proportion of completely unwetted cellulose ether is situated in the interior of these agglomerates. Complete dissolution of these agglomerates can, depending on the viscosity of the resultant solution and the mean polymer chain length, take up to 24 hours.

To reduce the lump formation occurring in the production of aqueous solutions of cellulose ethers, the cellulose ethers can be treated with surfactants, as described, for example, in U.S. Pat. No. 2,720,464.

Furthermore, it is desirable for some applications to have a certain open time of a few seconds up to a plurality of hours. Open time, or else solvation delay (SD), means that after mixing the components, including cellulose ether, a certain time further passes until the cellulose ether increases the viscosity of the mixture, but then very abruptly.

The combination of prevention of lump formation of the cellulose ether and open time SD is achieved chemically via crosslinking of the cellulose ethers. Crosslinking in this context means the linkage of at least two polymer chains which otherwise proceed separately via bi- or polyfunctional molecules, for example dialdehydes such as glyoxal (prior art), glutaraldehyde or structurally related compounds, and also diesters, dicarboxylic acids, dicarboxamides and anhydrides.

Reacting free hydroxyl groups of the cellulose ether with aldehydes to form hemiacetals produces a partial reversible crosslinking which, on dissolving the crosslinked cellulose ether in neutral or weakly acidic water, is cleaved again with a time delay. The result is an abrupt viscosity increase without lump formation after the distribution of the powder in the aqueous medium and also a defined open time SD which can be controlled via the degree of crosslinking by the amount of crosslinking reagent added.

The exact mechanism of crosslinking using different dialdehydes in the crosslinking of hydroxypropylcellulose is extensively described by S. Suto et al. in Journal of Material Science 28 (1993), pp. 4644 to 4650. In the examples described, low-molecular-weight chemical compounds are always used in the crosslinking and, if the crosslinking is to be disrupted again in a targeted manner, recur as low-molecular-weight compounds in the aqueous solution of the cellulose ether. This is particularly critical in the case of the generally used crosslinking agent glyoxal, because glyoxal in recent years has been newly toxicologically assessed, and has been classified as a category 3 mutagen and sensitizing substance. According to a new “EU Directive on dangerous preparations”, preparations which comprise at least 0.1% of a sensitizing substance must be labeled from 7.30.2003 with “Contains glyoxal. Can give rise to allergic reactions”.

It was an object of the present invention, therefore, to develop a method by which cellulose ethers can be reversibly crosslinked and which succeeds without the use of glyoxal, no longer releases the crosslinking reagent on dissolution in water, and, furthermore, in large-scale industrial production of crosslinked cellulose ethers does not lead to complex and costly modifications or additional treatment steps.

This object is achieved by a method of the generic type mentioned at the outset, the distinguishing features of which are that cellulose ethers having free OH groups are first admixed with chemical compounds containing at least one aldehyde group and at least one acid group, and then the acid groups and the aldehyde groups of the chemical compounds are reacted with the OH groups of the cellulose ethers.

The reaction of the acid groups and the aldehyde groups of the chemical compounds with the OH groups of the cellulose ethers preferably leads to an ester or hemiacetal bond.

The amount of chemical compound containing at least one aldehyde group and at least one acid group is according to the invention in the range from 0.01 to 0.1 mol per mole of cellulose ether.

The particular advantage of the present invention is that, during dissolution of the crosslinked cellulose ethers in water, low-molecular-weight substance is no longer eliminated from the inventively crosslinked cellulose ethers, since the ester group still remains intact, and that therefore problems in connection with the toxicological danger of the elimination products can no longer occur at all.

As a suitable chemical compound having at least one aldehyde group and at least one acid group, preference is given according to the invention to using a compound of the general chemical formula
HOC—[X]_{y}—COOH,
where X is a divalent alkylene group which has from 1 to 6 carbon atoms and can be saturated and straight-chain or branched, or a divalent saturated cyclo- or bicycloalkylene group having from 3 to 10 carbon atoms, or a divalent arylene group having from 6 to 10 carbon atoms, where these groups can further bear one or more substituents R which, in addition to hydrogen, can also be alkyl radicals having up to 4 carbon atoms, oxyalkyl radicals having up to 4 carbon atoms, OH groups, halogens, nitro groups, nitrile groups or mixtures thereof, and where y can be either 0, 1 or 2.

In a preferred embodiment of the invention, y in the general chemical formula is equal to 0 and the compound is glyoxylic acid which is available industrially without any problem.

In a further preferred embodiment of the inventive method, the commercially conventional cellulose ether is moistened with water or suspended in an organic suspension medium without passing into solution therein. The water content of the moistened cellulose ether is in the range between 10 and 80%, preferably between 40 and 70%, in the case of a mixture of cellulose ether and organic suspension medium preferably between 30 and 60%, based on the amount of cellulose ether used.

The chemical compound having at least one aldehyde group and at least one acid group is added to this mixture and incorporated to be homogeneous over a time period in the range of 1 to 60 min, preferably from 20 to 40 min.

The subsequent reaction of the aldehyde groups and the acid groups with the OH groups of the cellulose ethers takes place at temperatures in the range from 50 to 150° C., preferably in the range from 60 to 130° C., over a time period of from 1 to 120 min, preferably from 10 to 90 min. The exact time period depends on the intensity of the drying operation, that is to say on the performance of the drier.

Suitable organic suspension media in which the cellulose ethers can be crosslinked are, in particular, acetone, lower alcohols having from 1 to 4 carbon atoms, diethyl ether and also ethers having alkyl chains having up to 8 carbon atoms per chain, but also cyclic ethers such as dihydropyran, dihydrofuran, tetrahydrofuran or dioxane, ethylene glycol dimethyl ether, diethylene glycol dimethyl ether, triethylene glycol dimethyl ether, tetra-ethylene glycol dimethyl ether, straight-chain and branched hydrocarbons having up to 12 carbon atoms, and also cyclic compounds such as cyclopentane or cyclohexane, or aromatic compounds such as toluene, benzene, or alkyl-substituted toluenes or benzenes.

It is also conceivable to bring essentially dry pulverulent cellulose ethers into contact with a solution consisting of the crosslinker in a nucleophilic organic solvent or in water, by intensive mixing, for example in a customary mixing unit.

The above-described reaction of cellulose ethers with aldehyde- and acid-group-containing low-molecular-weight substances leads to cellulose ethers which are readily stirrable, without any risk of lump-formation, before, after a defined SD, a detectable viscosity development begins in the neutral pH range.

The length of the SD depends on the type and amount of the crosslinker used and is fundamentally influenced by pH level of the solution to be prepared. The higher the pH, the shorter the SD will be.

The inventive method will be described in detail hereinafter with reference to exemplary embodiments, without being restricted to the embodiments of the invention specifically described.

Determination of Viscosity:

Viscosities reported in mPa.s are determined by measuring 1.9% strength aqueous solutions of the corresponding cellulose ether, based on the dry content taking into account the current moisture of the powder, using a Hoppler falling-ball viscometer at 20° C.

Determination of Solvation Delay (SD):

The SD measurement is evaluated by a Brabender viscometer at 20° C., and evaluated with software support. The data in [BU] relate to Brabender viscosity units, which are directly proportional to a corresponding viscosity in mPa.s.

The cellulose ethers are reacted and prepared for a Brabender measurement by the following method:

An appropriate amount of the modified cellulose ether which depends on the expected viscosity is suspended in water of different pHs. The measurement is started with addition of the cellulose ether and, for a starting viscosity of approximately 35±2 BU (Brabender units), determined at the time point at which the viscosity exceeds twice the starting viscosity (solvation delay) and also the time point of the maximum viscosity development (gel structure) and the time point at which the viscosity is virtually equivalent to the effective end viscosity.

### EXAMPLE 1

400 g of methylhydroxylethylcellulose having a 60 000 viscosity stage and a water moisture of 45% were mixed intensively for 30 minutes with 200 g of ice, 2.2 g of citric acid, 1.84 g of sodium hydroxide solution (50% in water) and 7.5 g of glyoxylic acid (50% in water), comminuted using a disintegrator and milled wet. The milled product was dried for one hour at a temperature of 105° C.

The finished product had a solvation delay of 4.5 min and a final dissolving time up to complete viscosity development of 27 min. A chemical analysis found that the glyoxylic acid could not be washed out.

### EXAMPLE 2

500 g of 85 % strength isopropanol were placed in a temperature-controllable stirred vessel. To this were added 250 g of a solvent-moist hexylethylcellulose (HEC) (approximately 100 g of dry matter) and distributed homogeneously using a high-speed stirrer. To this mixture were then added 1.9 g of glyoxylic acid (50% strength), a pH of 4.5 being established. The suspension was mixed intensively and then filtered by suction via a filter funnel.

The product was dried for one hour under a reduced pressure of 100 hPa and at a temperature of 40° C. to remove the solvent, coarsely comminuted in a mixer unit and then heated for one hour at 105° C. The product was then milled to a median particle size of less than or equal to 250 μm on a suitable mill. Result: solvation delay=5 min, final dissolving time=18 min.

1. A method for producing temporarily crosslinked cellulose ethers having lump-free stirrability and solvation delay on stirring into aqueous solutions, in which cellulose ethers having free OH groups are first admixed in water or in an organic suspension medium at a temperature in the range from 0 to 40° C. with chemical compounds containing at least one aldehyde group and at least one acid group, and in which the acid groups and aldehyde groups of the chemical compounds are then reacted with the OH groups of the cellulose ethers to form an ester bond or hemiacetal bond, the cellulose ether not being dissolved in the water or the suspension medium.

2. The method as claimed in claim 1, wherein the acid groups and aldehyde groups of the chemical compounds are reacted with the OH groups of the cellulose ethers to form an ester or hemiacetal bond.

3. The method as claimed in claim 1, wherein the chemical compound having at least one acid group and at least one aldehyde group is a compound of the general chemical formula
HOC—[X]_{y}—COOH,
where X is a divalent alkylene group which has from 1 to 6 carbon atoms and can be saturated and straight-chain or branched, or a divalent saturated cyclo- or bicycloalkylene group having from 3 to 10 carbon atoms, or a divalent arylene group having from 6 to 10 carbon atoms, where these groups can further bear one or more substituents R which, in addition to hydrogen, can also be alkyl radicals having up to 4 carbon atoms, oxyalkyl radicals having up to 4 carbon atoms, OH groups, halogens, nitro groups, nitrile groups or mixtures thereof, and where y can be either 0, 1 or 2.

4. The method as claimed in claims 1, wherein the chemical compound having at least one acid group and at least one aldehyde group is glyoxylic acid.

5. The method as claimed in claims 1, wherein the amount of chemical compound containing at least one aldehyde group and at least one acid group is in the range from 0.01 to 0.1 mol per mole of cellulose ether.

6. The method as claimed in claims 1, wherein are selected from the cellulose ethers having free OH groups are selected from methylcellulose, ethylcellulose, carboxymethylcellulose, hydroxyethylcellulose, hydroxypropylcellulose, methylhydroxyethylcellulose, methylhydroxypropylcellulose or ethylhydroxyethylcellulose.

7. The method as claimed in claims 1, wherein the cellulose ethers are admixed with the compound containing at least one aldehyde group and at least one acid group over a time period in the range of from 10 to 60 min.

8. The method as claimed in claims 1, wherein the acid groups and the aldehyde groups are reacted with the OH groups of the cellulose ethers at a temperature in the range from 50 to 150° C. over a time period in the range of from 1 to 120 min.

9. The method as claimed in claims 1, wherein the cellulose ethers are first admixed in organic suspension media selected from acetone, lower alcohols having from 1 to 4 carbon atoms, diethyl ether, ethers having alkyl chains having up to 8 carbon atoms per chain, cyclic ethers ethylene glycol dimethyl ether, diethylene glycol dimethyl ether, triethylene glycol dimethyl ether, tetraethylene glycol dimethyl ethers straight-chain and branched hydrocarbons having up to 12 carbon atoms, cyclic hydrocarbon compounds, or aromatic hydrocarbon compounds.

10. (canceled)
